(19) United States
(12) Patent Application Publication
(10) Pub. No.: US 2014/0058878 A1
(43) Pub. Date: Feb. 27, 2014

(54) SYSTEM AND METHOD FOR SOURCING MEDICAL APPARATUS

(71) Applicant: Cross Source LLC, Fountain Hills, AZ (US)

(72) Inventor: Carrie Belaski, Fountain Hills, AZ (US)

(73) Assignee: Cross Source LLC, Fountain Hills, AZ (US)

(21) Appl. No.: 14/068,422

(22) Filed: Oct. 31, 2013

Related U.S. Application Data
(63) Continuation-in-part of application No. 13/907,358, filed on May 31, 2013, now abandoned.
(60) Provisional application No. 61/653,645, filed on May 31, 2012.

(51) Int. Cl. G06Q 30/08

(52) U.S. Cl. CPC G06Q 30/08
USPC 705/26.3

(57) ABSTRACT

The various embodiments of the auction systems and methods described herein provide a web based service that allows medical facilities to both sell and buy medical devices and supplies at a discount. This web based service will enable hospitals that otherwise would have a financial loss, to sell their soon to be expiring products at a discount, and at the same time allow facilities that have an immediate need for devices to purchase them at a lower price based on a more limited expiration than if bought directly from the manufacturer. This maximizes savings on behalf of the buyers and minimizes losses on behalf of the sellers while consolidating inventory in the overall medical device/supply market.

### CLAIM OF PRIORITY

This application is a continuation-in-part and claims priority to U.S. patent application Ser. No. 13/907,358 filed on May 31, 2013, entitled “System and Method for Sourcing Medical Apparatus” which claims the benefit of U.S. Provisional Patent Application Ser. No. 61/653,645 filed May 31, 2012 entitled “System and Method for Sourcing Medical Apparatus”, and is herein incorporated by reference in its entirety.

### FIELD OF INVENTION

The invention relates to a system and a method of sourcing in an auction-type environment that generally occurs in a closed system or in an open system such as the internet.

### BACKGROUND

Systems exist today such as eBay and Craigslist, they may reside on the internet, or a closed computing or server system, that brings potential buyers or consumers to products being sold or services being offered by sellers. Generally, the sellers offer the product/service at a fixed price and the buyer can choose to make a counteroffer for such product/service (Craigslist for example) and the buyer enters in to a bidding situation for the goods or services in an auction environment, such as in the eBay® system. This approach has assisted many companies and inventory managers to reduce inventory and improve working capital (and liquidity) by providing an outlet for disposing of excess or expiration date-sensitive inventory. It would be desirous to have a solution to expiration date-sensitive inventory of medical items for hospitals and clinics.

### SUMMARY

The various embodiments described herein of a Medical e-Source system, medical device auctioning system (or Auction Co.), or remote server auctioning interface serves as a private marketplace for medical facilities (e.g., hospitals and clinics) that have a need to buy devices, pharmaceuticals and supplies at a discount. Similarly, these medical facilities may also have a need to sell devices, pharmaceuticals and supplies to avoid substantial losses from expired or unusable product or inventory. The system also provides medical facilities the ability to purchase a single item that otherwise would have to be purchased in multiple quantities, and a manner in which to buy items unavailable from the manufacturer due to issues such as backorders. Members pay annual membership/access fee, and incur a fee (i.e. transaction, buyer, percent total) on every sale or purchase. The medical e-source system serves as the accounts payable, and receivables department for all transactions occurring on the medical e-source system website. The medical e-source system also serves as a screening facility of all member/users, and reserves the right to revoke privileges of any member at any time

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 shows a general auction environment for engagement of buyers and sellers by an auctioning facilitator as taught herein;

FIG. 2 shows a general shipping process flow for medical items managed by auctioning facilitator as taught herein; and

FIG. 3 shows a general payment and collection reconciliation process for the buyers and sellers managed by auctioning facilitator as taught herein.

FIG. 4 shows a process flow of resale of medical supplies between medical facilities/providers as taught herein.

FIG. 5 shows a process flow of a remote server and associated remote auction interface.

FIG. 6 shows a process flow of product submission.

FIG. 7 shows a process flow of product purchasing.

### DETAILED DESCRIPTION

The medical e-source system is an innovative web based service that allows medical facilities to both sell and buy medical devices and supplies at a discount. This web based service will enable hospitals that otherwise would have a financial loss, to sell their soon to be expiring products at a discount, and at the same time allow facilities that have an immediate need for devices to purchase them at a lower price based on a more limited expiration than if bought directly from the manufacturer. This maximizes savings on behalf of the buyers and minimizes losses on behalf of the sellers while consolidating inventory in the overall medical device/supply market.

The medical e-source system is a members only, web based marketplace for medical supplies, devices, pharmaceuticals and the like. Members (including hospitals, ambulatory surgery centers, physician offices, clinics, etc.) pay a nominal annual fee per facility which allows them to be linked to similar facilities across the country where they can buy and sell products with confidence. Each facility will be vetted in terms of Joint Commission on Accreditation of Healthcare Organizations (JCAHO) certification (or similar accreditation), Magnet status, or other patient care, patient safety or health care compliance certifications that provide an indication of a excellence in safety for the staff and/or facility. These types of certification requirements ensure each member is a legitimate, currently operating health care facility, purchasing products under the order of a physician. Members will also be obligated, contractually or otherwise, to only sell devices that are in sterile and usable condition and still in the original packaging that has not been altered in any way. Additionally, the systems described herein will prompt a seller to post products that were procured directly from the manufacturer or authorized manufacturer distributors. The medical e-source system will track complaints under each individual account, should an account incur multiple complaints in regards to products sent they may be removed from medical e-source system membership in regards to being able to sell their supplies. They may however still be able to purchase supplies.

The medical e-source system Network serves as an administrator to the web based marketplace, and also the accounts receivable and accounts payable departments. The functionality of the Network serves to facilitate system maintenance where the website members are able to buy and sell their goods. Moreover, the medical e-source system collects annual membership fees from each facility and assigns them IDs and passwords that correspond to their billing and shipping addresses, and whether the facility is a for profit or not-for profit facility. Additionally, the medical e-source system tracks complaints about all members and determines whether they can buy and/or sell merchandise depending on their history within the network. A reputation point system will be maintained. The medical e-source system may also process accounts payable and receivables in regards to transactions but never takes possession of supplies/devices.

In a related embodiment, a computer implemented system for auctioning at least one product from the group consisting of a medical apparatus, supply, pharmaceutical and medical device between a first party and a second party is provided comprising; a remotely accessible auction server configured to access available product from the inventory of the first party, the identification of the first party not being made accessible to the second party. The system also includes a means for placing a purchase order for the product through the auction server by the second party without initially identifying the second party to the first party. The system further includes a means for transmitting a shipping order to the first party (seller) of the product to the second party (buyer) upon the network securing payment from the second party for the product. In an alternative embodiment, the system further includes a means for transmitting a shipping order to the first party (seller) of the product to the second party (buyer) without securing a payment Once the product is shipped and/or received, an invoice is generated by the network system. The invoice is then sent to the second party (buyer). Once the second party (buyer) remits payment to a third party, such as a network administrator or accounting system, the first party (seller) is notified and the first party is credited for the sale.

In yet another related embodiment, a computer implemented method for auctioning at least one product from the group consisting of a medical apparatus, supply, pharmaceutical and a medical device between a first party and a second party is provided comprising the steps of providing a remotely accessible auction server configured to access available product from the inventory of the first party, the identification of the first party not being made accessible to the second party. The method optionally includes the step of placing a purchase order for the product through the auction server by the second party without identifying the second party to the first party. The method further includes the step of, upon ordering a product by the second party, the system will transmit a shipping order to the first party of the product that contains the shipping information of the second party.

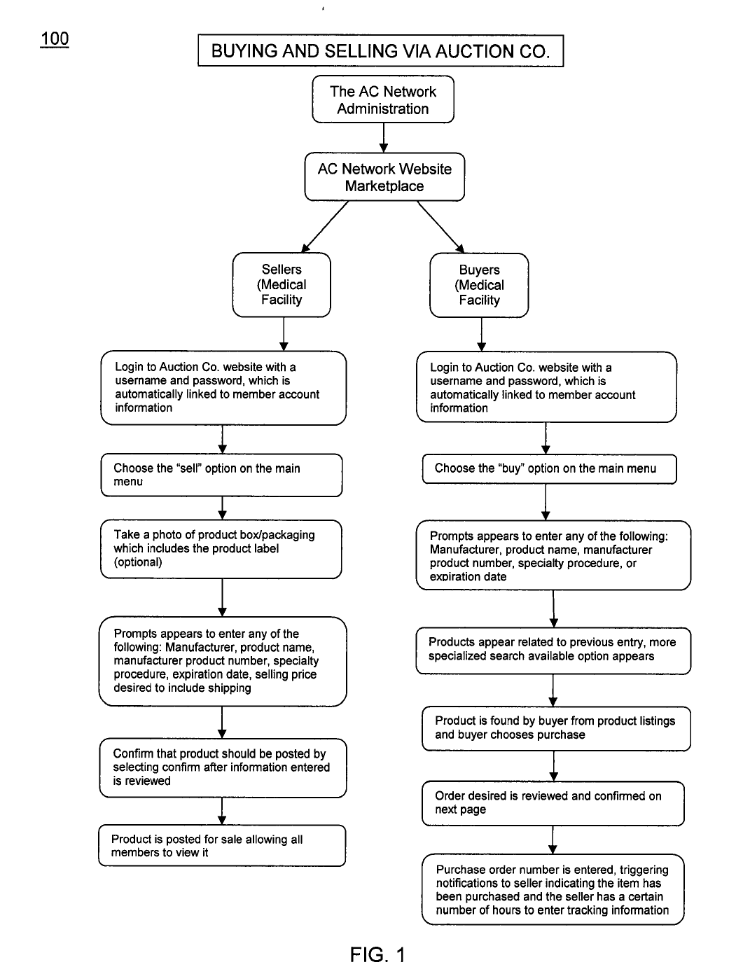

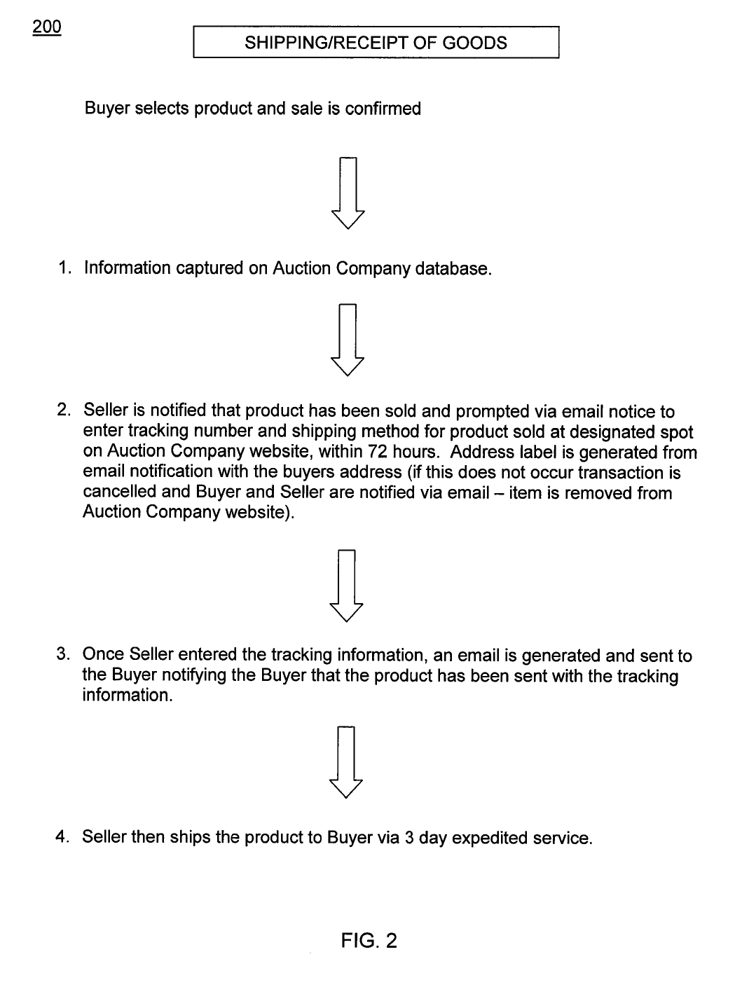

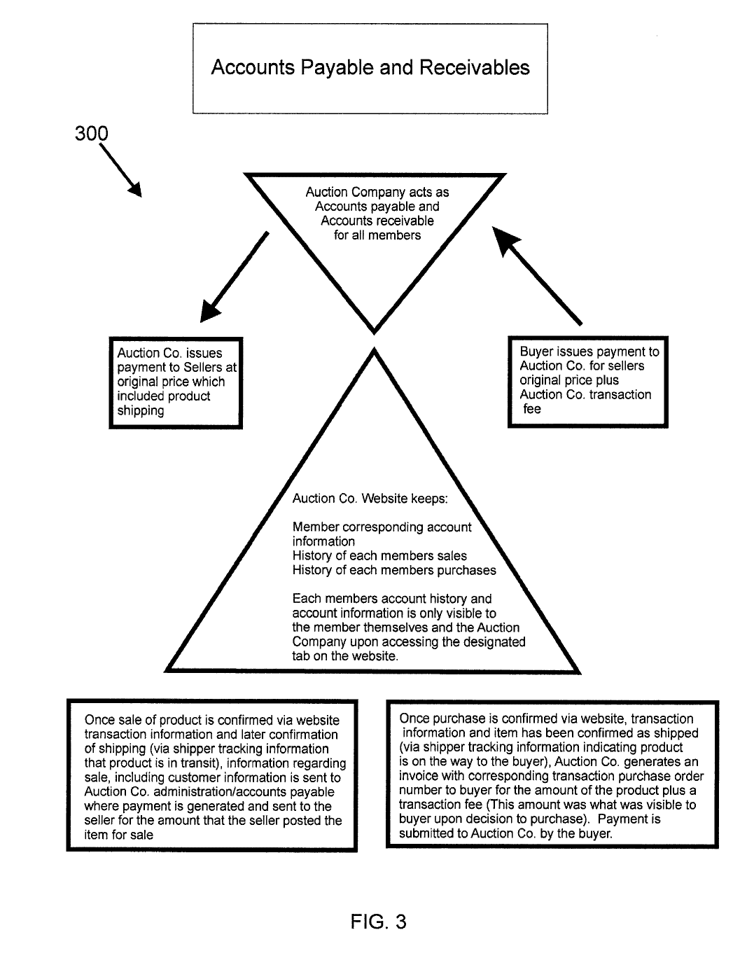

Referring now to FIGS. 1-4, the Figures overall describe several aspects of the medical e-source auctioning system of the invention. In particular, FIG. 1 shows an example embodiment of auction environment 100 for engagement of buyers and sellers by an auctioning facilitator. FIG. 2 shows an example embodiment of shipping process flow 200 for medical items managed by auctioning facilitator. FIG. 3 shows an example embodiment of payment and collection reconciliation process 300 for the buyers and sellers managed by auctioning facilitator. A challenge to be solved by the invention described herein includes the scenario of a purchasing (or supply chain or inventory manager) person within a medical facility that recognizes that they have products (includes but is not limited to medical devices, supplies, pharmaceuticals and the like) in inventory that will expire soon (or be considered obsolete) that will not be used and that cannot be returned to the manufacturer.

In this example embodiment, the inventory manager uses a electronic device, such as an Apple, Inc. based application (i.e. iPhone or iPad), that after logging on to a secured website via a username and password specific to their account, the inventory manager can upload or send a photo of the device or product and then uses a series of dropdown menus to categorize the device and post it for sale (or exchange or donation) on the medical e-source system website. In a related embodiment, the electronic device may be a desktop or smartphone or any other device that facilitates wired or wireless access to the facility's internet or network.

Referring again to FIG. 1, in this example embodiment only information regarding the product the facility desires to sell is posted. The information included in the posting is the product manufacturer, product name, manufacturer product number, lot/serial number, the specialty it is used for or its specific application (optional), expiration date, quantity available for sale, whether the seller is a for-profit or not-for -profit entity, location of seller (state, territory, country, etc.) and price. The item becomes visible to other buyer/members that are logged in and are searching the medical e-source system website for that product found by any of the following (but not limited to) categories: manufacturer, product name, manufacturer product number, specialty or specific application, and expiration date.

Referring again to FIGS. 2 and 3, the buyer upon finding the product needed selects the buy option, and confirms the purchase and price, enters a purchase order number. An air bill is generated at the selling facility along with a form indicating which products need to be sent under the corresponding air bill. Although an electronic message with the aforementioned information is preferred, the system is also equipped to generate the information by other known means. In this example embodiment, it is highly recommended that selected items leave the selling facility within 72 hours.

In this example embodiment, the purchasing facility issues a purchase order within the website ordering form. An invoice is generated by the medical e-source system auctioneer once confirmation that the related air bill for the products has left the selling facility and sent to the buying member.

The selling facility is then notified via email and under their account history page within the site that the device has been sold. The medical e-source system generates payment to the selling facility when the item has been confirmed to have been shipped via entry of tracking company/number information on the medical e-source system website and the buying member has not rejected the product due to inability to use it due to packaging or other issue. The tracking number must be entered within a period of time (i.e. 5 days) of the item being selected for purchase by the buyer. The time can be set in hours, days or weeks. Additionally, the system is equipped to send a warning to the seller at a time before the tracking number entry time limit (warning time limit). If the tracking information is not entered within the systems set warning time limit, the system initiates a reminder to the seller that the transaction will be cancelled without the tracking number being entered before the time limit expires. All transactions can be seen in the pending transaction/completed transaction pages of the member interface (i.e. webpage) assigned to each member via their user name and password.

In another example embodiment, Doctors Hospital owns a stock of 5 implantable devices, such as incontinence slings, due to expire in 90 days. The manufacturer of the medical device will not accept returns within 6 months of expiration and the physicians at Doctors Hospital no longer have a need for these slings or will not be able to use them within the next 90 days. Manufacturer's list price is $1000/sling and that is close to what the hospital paid for each device. They are posted on the Med-e-source Networks website at a 40% discount off of manufacturer's list price ($600 includes shipping) where Good Samaritan Hospital (potential buyer) in another part of the country sees that they are for sale. Good Samaritan has mandated that their purchasing personnel always check the Network first for product needed for already scheduled surgeries, prior to ordering from the manufacturer. Good Samaritan has 3 upcoming implantable sling procedures scheduled within 60 days. They purchase the 3 slings at 40% off of manufacturers list price from Doctors Hospital, saving Good Samarian a total of $1600. On the other hand, Doctors Hospital has reduced their losses from $3000 to $1200, thereby recouping $1800 from older inventory that can be used to buy new product or other product from the Network.

### EXAMPLE 1

BUYING through the Network by Good Samaritan(savings realized):

Good Samaritan bought 3 slings for a total cost of $1800 ($600 each-includes shipping charges and medical e-source system transaction fee) vs.

Manufacturers cost of ordering 3 new slings $3,000.00+shipping Good Samaritan savings of 40% or $1,200 on 3 new slings SELLING by Doctors' Hospital via the Network: Doctors hospital sold 3 slings for $1,800.00 ($600 each) $1,800.00

TOTAL $1,800.00

Loss of −$1,200 (+shipping fees paid to get products to buying member)

vs.

Losses had resale not occurred −$3,000.00

Pricing of devices/supplies (an example of the pricing model of the invention): All products posted for sale will be priced by the seller, the seller will include any shipping charges in the price requested. The medical e-source system will add a buyer's fee, such as a % amount of the total price posted by the seller, or the greater of a % amount of the total price of the seller or a pre-set value. This buyer's fee will be added to the seller's price and will be included in the amount visible when the item becomes listed for sale.

For example: Good Samaritan Hospital wants to sell a item for $1000 (this is for the item and includes the shipping fees for the item to get from seller to buyer), and the medical e-source system % transaction fee is 9%, the item is then posted for sale for $1090. $1090 is the only price that the buyer sees, and this includes all costs related to the transaction, purchase, and shipping. Alternatively the system may itemize the cost of the product and any additional fees.

Member Facility Setup and maintaining the integrity of the medical e-source system network. All members are issued a member ID number and password to gain access to the medical e-source system website. Medical facilities that want to be members must be Joint Commission Accredited/Certified, Magnet status or the like in order for their membership to be activated. Once a member, the medical e-source system will keep records of product complaints, which may prompt the system to revoke access to sell products. No members outside of Joint Commission Accredited/Certified, Magnet status or the like facilities will be allowed membership to the medical e-source system.

Members of the medical e-source system, in this example embodiment, need nothing more to get started than access to a computer/smart phone/ tablet or other device with internet capabilities, for the designated employee posting products for sale (photo for product posting is optional). Upon becoming a member, the medical e-source system will provide each account with an account number, user name and password and ID # for all transactions within the site. The ID numbers will be used in place of actual contact information to reduce the possibility that a member hospital would try to engage in transactions with their medical e-source system connection outside of the Network. The only time the seller will have access to the buyer's information will be when the purchase is confirmed and the air bill with the buyers address is generated.

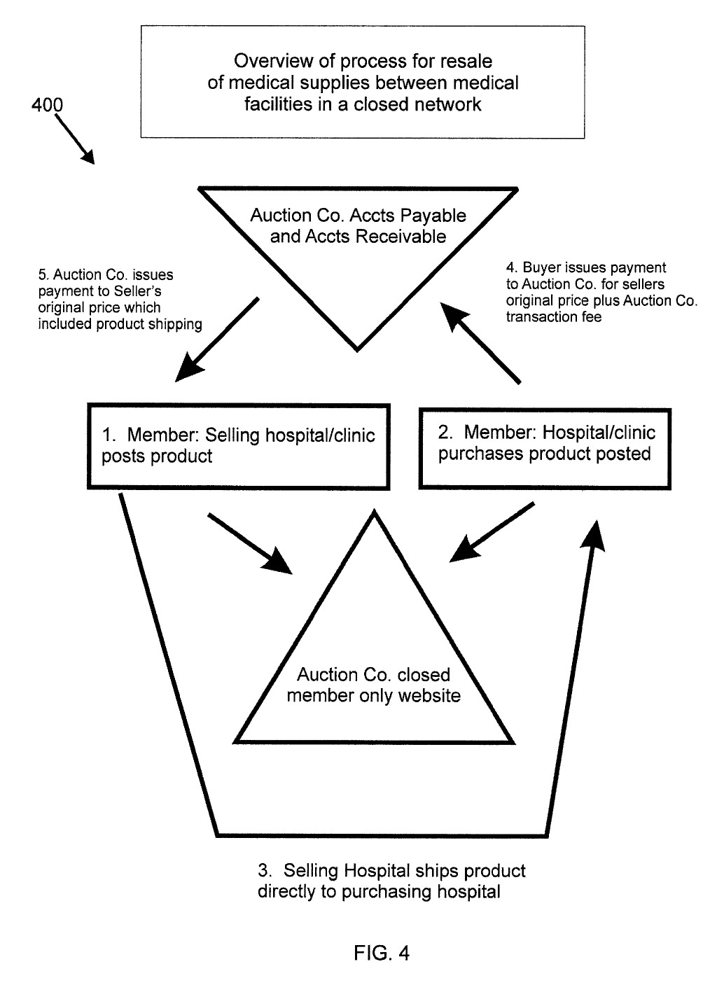

Referring to FIG. 4, process 400 illustrates the resale of medical supplies between medical facilities in a closed network environment or system. In particular, in step 1, the selling member posts the product on the Auction Co. server, which in this example is only open to members. In step 2, the purchasing member sees and purchases the product through the Auction Co. server. In step 3, the seller medical facility ships the product to the buyer medical facility and then the Buyer facility effects payment to the Auction Co. Auction Co. then issues payment to the seller facility including the shipping costs and minus a predetermined handling fee or commission for the service. This example embodiment is not necessarily limited to medical facilities and medical products and is applicable in other commercial areas where excess and time sensitive inventory exists and the manufacturer cannot take back inventory due to health, safety, or obsolescence.

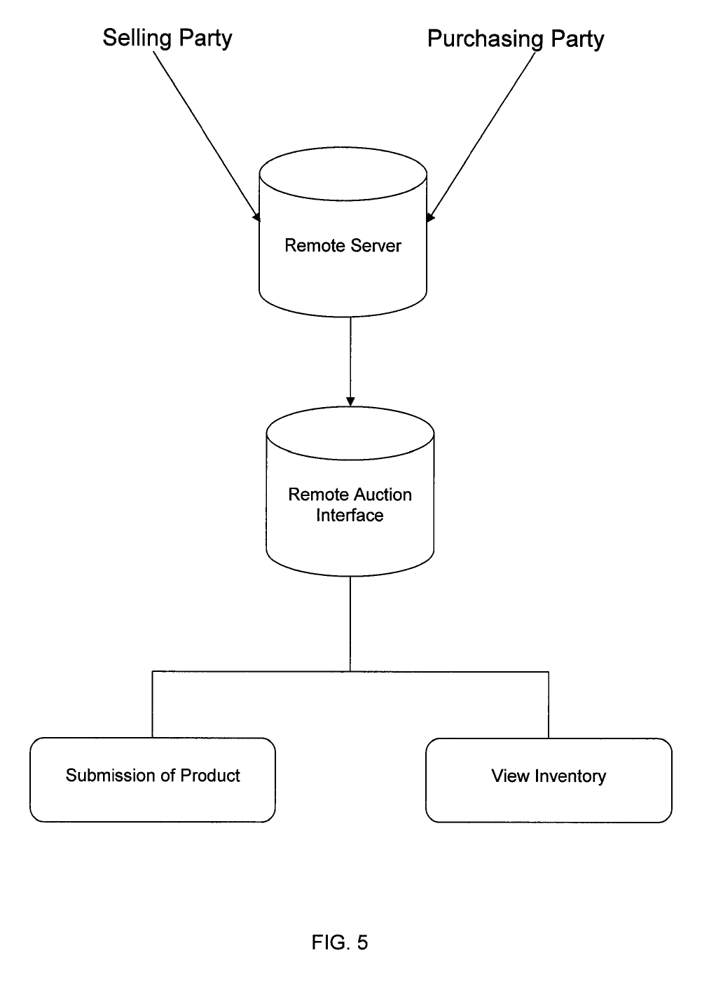

Referring now to FIGS. 5-7 where a related alternative embodiment of a computer implemented system is described to provide at least one product to be submitted and auctioned by a selling party to a purchasing party. In order for a party to gain access to the remote server a party must register. Although a number of defining features may be requested during the registration process, the user will be prompted to create a login and password. Additionally, the user must complete a series of fields to verify that the registrant is a facility that can both sell and purchase health care products.

Although not wanting to be bound by any particular theory, a buyer or seller are typically organizations such as a hospital, nursing homes, home-health care organizations, a research facility, a health care clinic, a doctors office, government facility, a surgery center and a medical center. In a preferred embodiment the buyer and seller must have obtained a certification such as JCAHO and the like. Moreover, although the products bought and sold will vary depending on the type of institution utilizing the remote auction interface, products such as medical devices, hospital supplies, pharmaceuticals, surgical instruments, nutraceuticals, medical equipment, implants, diagnostic instrument, medical hardware and medical disposables are within the scope of the invention.

Once a user is registered on the remote server, the user will gain access to the remote auction interface. This interface allows users to submit products, review inventory and pay invoices. Although the specific means and functionality may vary the system will provide a user a means to submit products, and view available products from an inventory list. The specific means are known to those skilled in the art. In another aspect of the disclosure described herein, the identification of each party will not be made accessible to another party, until a purchase is made. This provides for a certain level of anonymity while registrants are looking for particular products and or supplies.

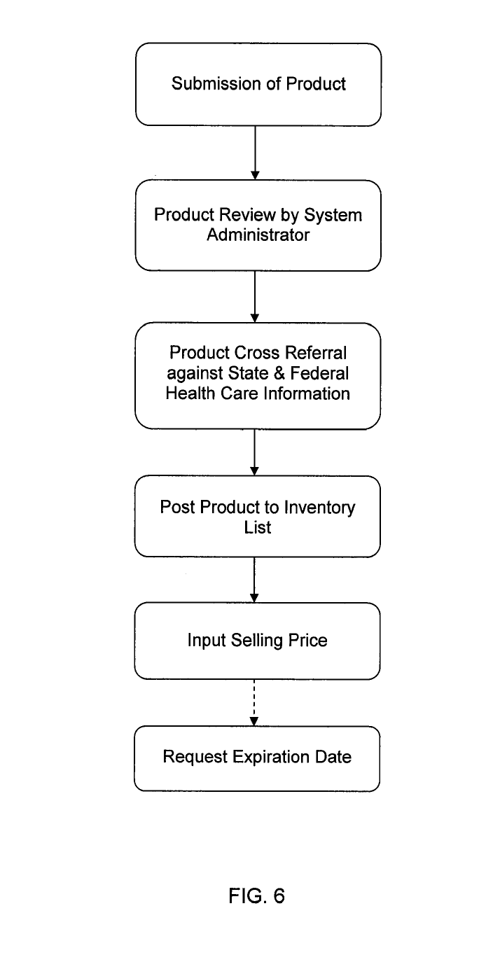

Referring now to FIGS. 5 and 6, when a selling party, after registration, would like to submit products on the remote server the first party submits a product, along with the selling price and other additional product information. Additionally, the selling party is required to include the expiration date of the product, if applicable. In an alternative data input sequence, once the product is posted, the selling party is allowed to establish a selling price for the product and include the expiration date of the product, if applicable. Once the product is submitted the product information is placed in a queue for review by a system administrator using known metrics. One type of system administrator may be an individual. In an alternative embodiment, the system will be programmed with metrics to provide a regulatory check in order to cross reference the product. These metrics include state regulations, federal regulations and product recall information. If the product is compliant with specific designated metrics, the product is posted to the inventory list. Alternatively, in the event that the product does not comply with the required state regulations, federal regulations or product recall information, the product is not posted on the remote auction interface.

Once the product is placed on the inventory list the system can optionally be set to initiate automatic price reductions for the product as the expiration date nears. If the expiration date of the product has occurred, the system is programmed to automatically remove the product from the inventory list. The system may optionally be programmed to remove a product from an inventory list a set time prior to expiration. Additionally, the system may also provide a means for notifying the selling party to dispose of the expired product. Furthermore the system may initiate a notification sequence that provides the seller with information (i.e. expiration date approaching, product expired and removed from inventory list, reminder to discard expired products, etc.).

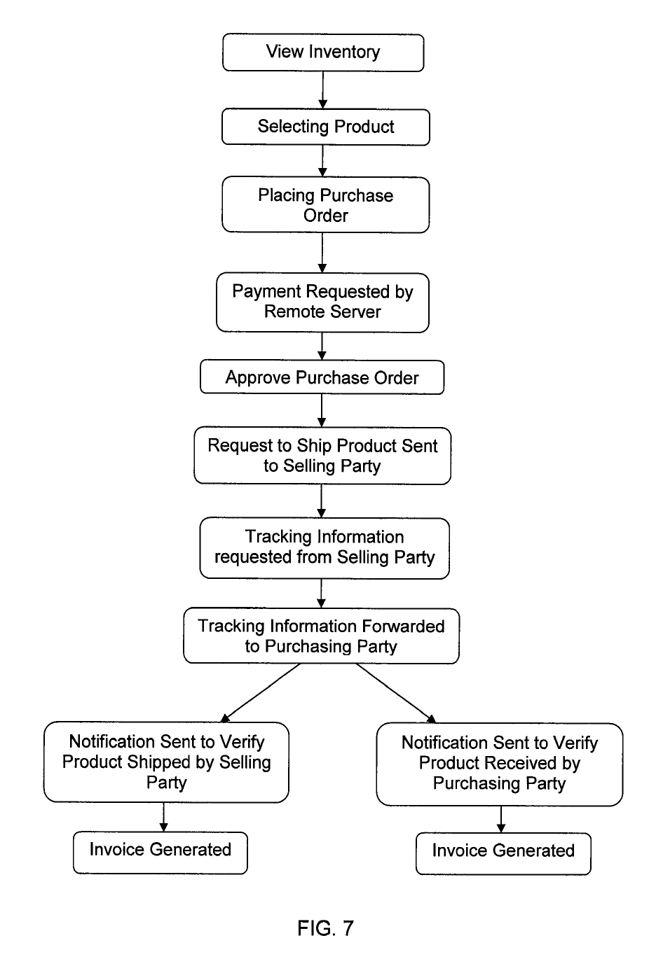

Referring now to FIGS. 5 and 7, the remote auction interface also includes a computer implemented means of viewing inventory that will allow a user to search for particular products based on a number of various search categories. Although not exclusive, some preferred product categories include manufacturer information, device type, disease, procedure, brand name and generic name. Once a desired product is located, the remote auction interface further includes a means of selecting a product(s). Once a product is selected remote user interface further comprises a means for placing a purchase order through the remote server. A member may also solicit a particular product to a membership list. An additional notification is sent to the soliciting party once the desired product is posted on the inventory list.

Once the order is placed, the remote server will transmit a shipping order to the selling party and provide a request to the selling party to ship the selected product(s) to the buying party. An optional step may further require that payment is verified, secured or approved by the buying party before a request to ship the product is initiated and sent to the seller.

Once the request to ship the product is initiated, the remote server will prompt the selling party to include tracking information which is forwarded to the buying party. In related additional optional steps, the system described herein may include automated cancel orders if a tracking number is not submitted within a certain period of time. Although not wanting to be bound by a particular time, a tracking number will be required to occur within 12 hours, 24, hours, 48 hours, 72 hours, 96 hours, 120 hours, 144 hours and 168 hours. Additionally, another additional optional step may include requesting verification of receipt of the product from the buying party. Once the buying party has purchased a product, the remote server will trigger the auctioning system to invoice the buying party. This invoice may be initiated upon the purchase or receipt of the product(s). Once the payment is received, it is credited to the selling party in the form of a credit realized monthly, or may alternatively be submitted immediately to selling party.

Examples of related systems for selling, buying or acquiring products or items are described in U.S. Pat. No. 7,340,401 issued on Mar. 4, 2008; U.S. Pat. No. 7,711,603 issued on May 4, 2010; and U.S. Pat. No. 8,050,675, issued on Nov. 1, 2011 each of which is herein incorporated by reference in their entirety.

While the various embodiments of the invention have been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer implemented system for auctioning at least one product between a first party and a second party, comprising:
Registering a first party on a remote server to allow access to said remote server wherein said first party is a selling party;
Registering a second party on said remote server to allow access to said remote server wherein said second party is a purchasing party; and
Accessing a remote auction interface configured to submit products, and view available products from an inventory list, the identification of each party not being made accessible to the other party until a product purchase order initiates.

2. A computer implemented method for auctioning at least one product according to claim 1 wherein said remote auction interface comprises a means of viewing inventory; a means of selecting at least one of said products and a means for placing a purchase order for said product through said remote server.

3. A computer implemented method for auctioning at least one product according to claim 2 wherein said remote auction interface further comprises a means for transmitting a shipping order to said selling party of said product to be shipped to said purchasing party.

4. A computer implemented method for auctioning at least one product according to claim 3 wherein said registering said first party further comprises the step of allowing said first party to submit at least one product.

5. A computer implemented method for auctioning at least one product according to claim 4 wherein said submission is placed in a queue for review by a system administrator.

6. A computer implemented method for auctioning at least one product according to claim 5 further comprising the step of cross-referencing said submission against state regulations, federal regulations and product recall information.

7. A computer implemented method for auctioning at least one product according to claim 6 wherein said submission upon being cross-referenced is posted on said remote auction interface and added to said inventory list.

8. A computer implemented method for auctioning at least one product according to claim 6 wherein said submission upon being cross-referenced does not conform to required state regulations, federal regulations and product recall information and is not posted on said remote auction interface.

9. A computer implemented method for auctioning at least one product according to claim 7 wherein said products are selected from a group consisting of medical devices, hospital supplies, pharmaceuticals, surgical instruments, nutraceuticals, medical equipment, implants, diagnostic instrument, medical hardware and medical disposables.

10. A computer implemented method for auctioning at least one product according to claim 7 wherein said inventory list is searchable by categories selected from a group consisting of manufacturer, device type, disease, procedure, trademark, brand name and generic name.

11. A computer implemented method for auctioning at least one product according to claim 7 wherein said selling party sets a price for said product.

12. A computer implemented method for auctioning at least one product according to claim 11 wherein said price is reduced between said submission of product to a date of expiration of said product.

13. A computer implemented method for auctioning at least one product according to claim 12 wherein upon a pre-selected time occurring, said product is removed from said inventory list wherein said pre-selected time is between said submission of product to said date of expiration.

14. A computer implemented method for auctioning at least one product according to claim 1 wherein said first party and said second party are selected from a group consisting of a hospital, nursing homes, home-health care organizations, a research facility, a health care clinic, a doctors office, government facility, a surgery center and a medical center.

15. A computer implemented method for auctioning at least one product according to claim 14 wherein said parties are JCAHO certified or Magnet status.

16. A computer implemented method for auctioning at least one product according to claim 7 further comprising the steps of selecting a product from said inventory list and initiating a purchase order of said product.

17. A computer implemented method for auctioning at least one product according to claim 16 wherein upon initiating a purchase order said remote server requests payment and optionally verifies payment.

18. A computer implemented method for auctioning at least one product according to claim 17 wherein said remote server sends a shipping order to said selling party with purchasing party's shipping information.

19. A computer implemented method for auctioning at least one product according to claim 18 wherein said tracking information of said product being shipped is requested.

20. A computer implemented method for auctioning at least one product according to claim 18 wherein said tracking information of said product being shipped is required to receive payment.

21. A computer implemented method for auctioning at least one product according to claim 19 wherein said tracking information is forwarded to said purchasing party.

22. A computer implemented method for auctioning at least one product according to claims 20 wherein said tracking information is forwarded to said purchasing party.

23. A computer implemented method for auctioning at least one product according to claim 1 wherein said registering said first party further comprises the step of allowing said first party to submit at least one product.
